(19) United States
(12) Patent Application Publication
(10) Pub. No.: US 2026/0061385 A1
(43) Pub. Date: Mar. 5, 2026

(54) MASS PRODUCTION APPARATUS FOR HIGH-PURITY LITHIUM SULFIDE

(71) Applicant: LAKE TECHNOLOGY., LTD, Sejong-si (KR)

(72) Inventors: Sang Yun LEE, Sejong-si (KR); Seong Hoon JEONG, Cheonan-si Chungcheongnam-do (KR); Se Hyun KIM, Sejong-si (KR); Jeong Hyeon PARK, Daejeon (KR); Sung Yoon BAEK, Sejong-si (KR); Taek Seung YANG, Icheon-si Gyeonggi-do (KR); Yik Haeng CHO, Daejeon (KR); Chang Ho SONG, Chungcheongbuk-do (KR); Jin Dong KIM, Sejong-si (KR)

(73) Assignee: LAKE TECHNOLOGY., LTD, Sejong-si (KR)

(21) Appl. No.: 19/378,952

(22) Filed: Nov. 4, 2025

Related U.S. Application Data
(63) Continuation of application No. PCT/KR2025/008149, filed on Jun. 13, 2025.

(30) Foreign Application Priority Data
Aug. 8, 2024 (KR) 10-2024-0106343

(51) Int. Cl. B01J 8/22; B01J 8/00; B01J 8/18; C01B 17/22

(52) U.S. Cl. CPC B01J 8/222; B01J 8/006; B01J 8/1827; B01J 8/1836; C01B 17/22; B01J 2208/00176; B01J 2208/00867; B01J 2208/00911; C01P 2004/61; C01P 2006/12; C01P 2006/80

(57) ABSTRACT

When producing lithium sulfide by a reaction between a lithium raw material and hydrogen sulfide, the reaction is performed under relatively mild conditions compared to the conventional technology, so frequent repairs or replacements due to corrosion and breakdown of reactors and piping are not required, thereby improving the economic efficiency of the process. Since unreacted hydrogen sulfide and a solvent from which moisture has been removed are reused, process costs are reduced so that economic feasibility in mass production is ensured. Furthermore, moisture and water vapor generated in a lithium sulfide production reaction are effectively removed to prevent a reverse reaction into lithium hydroxide and promote a forward reaction so that high-quality lithium sulfide can be produced with high purity and high yield. In addition, particle size may be controlled in the micrometer range without a separate crushing space or crushing stage, thereby providing excellent convenience and mass production.

### CROSS-REFERENCE TO RELATED APPLICATIONS

This application is a continuation of International Application No. PCT/KR2025/008149 filed on Jun. 13, 2025, which claims priority to Korean Patent Application No. 10-2024-0106343 filed on Aug. 8, 2024, the entire contents of which are herein incorporated by reference.

### TECHNICAL FIELD

The present invention relates to an apparatus for producing lithium sulfide.

### BACKGROUND ART

Lithium secondary batteries have high energy density and long lifetimes, and thus they are widely used in electronic devices such as home appliances, laptop computers, and smartphones. Recently, their utilization has been greatly increasing, as they are also mounted on electric vehicles (EVs) and hybrid electric vehicles (HEVs).

Lithium-ion secondary batteries that are mainly used today have been widely used as the main power source for mobile phones, laptop computers, and PCs since mass production began in 1991, thanks to their high energy density and output voltage. However, an organic electrolyte that is included to facilitate the migration of lithium ions includes a risk of explosion under overheating and overcharging conditions. Furthermore, it may easily ignite in the presence of an ignition source, and side reactions within the battery may cause gas generation, deteriorating battery performance and stability.

To overcome these shortcomings of lithium-ion secondary batteries, active research and development is underway on all-solid-state lithium secondary batteries. All-solid-state lithium secondary batteries not only reduce the risk of explosion by employing a solid electrolyte instead of a volatile electrolyte, but also offer the advantage of dramatically improving battery energy density by allowing the use of lithium metal or a lithium alloy as a negative electrode material.

Today, among the solid electrolyte candidates that may be included in all-solid-state batteries, sulfide-based solid electrolytes, known for their high ductility and ionic conductivity, are evaluated as suitable for manufacturing high-capacity, large-scale secondary batteries, and lithium sulfide (Li₂S) is evaluated as a key material in the manufacturing process of such sulfide-based solid electrolytes. Various methods of synthesizing lithium sulfide are known, but the most common method is known to be allowing lithium metal, such as lithium hydroxide (LiOH) or lithium carbonate (Li₂CO₃), to react with hydrogen sulfide (H₂S).

Meanwhile, hydrogen sulfide gas is a highly corrosive gas, and when it reacts with a lithium compound in a conventional metal reactor, it corrodes equipment such as the reactor and piping, requiring frequent repairs and replacements and thereby reducing the economic feasibility of lithium sulfide mass production.

In addition, reacting a lithium compound, such as lithium hydroxide, with hydrogen sulfide inevitably generates water vapor, which not only interferes with the contact between lithium metal and hydrogen sulfide, reducing the yield of lithium sulfide, but also reacts with lithium sulfide to accelerate a reverse reaction of lithium sulfide into lithium hydroxide, thereby reducing the purity of the resulting lithium sulfide. Furthermore, moisture may cause agglomeration between the produced lithium sulfide particles, deteriorating product quality.

Accordingly, the present inventors have studied a method for economically producing lithium sulfide having a size of several to several tens of microns by establishing a high-purity, high-yield process in which a lithium compound and hydrogen sulfide are allowed to react under relatively mild conditions, moisture is removed through gas bubbling to promote a forward reaction, and moisture is removed from a solvent and unreacted hydrogen sulfide, which are then reused in the production of lithium sulfide, thereby completing the present invention.

### DISCLOSURE

### Technical Problem

The present invention aims to solve the above-described problems and provides an apparatus for producing lithium sulfide by designing reaction conditions and an apparatus suitable for mass-producing high-purity lithium sulfide at high-yield through a reaction between a lithium raw material and hydrogen sulfide (H₂S), removing moisture by using gas bubbling to promote a forward reaction, reusing unreacted hydrogen sulfide and a solvent to ensure economic feasibility, and controlling particle size without a separate crushing space or a crushing step to provide excellent convenience and mass-production properties.

### Technical Solution

The invention of the present specification provides an apparatus for producing lithium sulfide, including: a reaction chamber having a predetermined reaction space and provided with a solvent and a lithium raw material; a hydrogen sulfide supply portion for supplying hydrogen sulfide to the reaction chamber; a heating portion for heating the reaction space; a lithium sulfide recovery portion for receiving and recovering lithium sulfide produced by a reaction between the lithium raw material and the hydrogen sulfide within the reaction chamber; a condensation portion for recovering and selectively condensing gas discharged from the reaction chamber; a hydrogen sulfide resupply portion for recovering unreacted hydrogen sulfide (H₂S) passing through the condensation portion and supplying it back into the reaction chamber; and a solvent resupply portion for selectively recovering a solvent from a mixture of the solvent liquefied in the condensation portion and water and supplying the solvent back into the reaction chamber.

For example, the apparatus may further include an inert gas supply portion that supplies inert gas by bubbling it into the reaction chamber.

For example, the apparatus may further include, within the reaction chamber, a stirring member that promotes a reaction between the lithium raw material and hydrogen sulfide or to crush a product.

For example, the apparatus may further include an inline mixer in a lithium sulfide recovery line that connects the reaction chamber and the lithium sulfide recovery portion.

For example, the reaction chamber may be made of one material selected from the group consisting of Hastelloy, stainless steel (SUS), alumina, quartz, and a combination thereof.

For example, hydrogen sulfide supplied to the reaction chamber from one or more devices selected from the hydrogen sulfide supply portion and the hydrogen sulfide resupply portion may be bubbled by a sparger or an inline dispersing device before being supplied into the reaction chamber.

For example, the heating portion may be a device mounted on an outer surface of the reaction chamber and heats the reaction space to a temperature ranging from 120 to 300° C.

For example, the lithium raw material may be one selected from lithium hydroxide (LiOH), lithium hydroxide monohydrate (LiOH·H₂O), lithium carbonate (Li₂CO₃), and a combination thereof.

For example, the solvent resupply portion may be a Dean-Stark trap or oil-water separator that separates solvent and water by using difference in boiling point or specific gravity of substances.

For example, the lithium sulfide recovery portion may include a filter reactor or a vacuum filter, and when the lithium sulfide recovery portion is a filter reactor, it includes one or more selected from a blower, an impeller, and a filter member (F).

For example, the blower may be a device that is provided on a side end or top of the lithium sulfide recovery portion and generates a gas flow in a horizontal or vertical direction.

For example, the impeller may be provided so as to be movable in up, down, left, and right directions within the lithium sulfide recovery portion and have one or more shapes selected from a paddle, a propeller, and a turbine.

For example, the filter member may be made of one material selected from Hastelloy, stainless steel (SUS), and a combination thereof and may be a mesh filter that sieves particles with a particle size of 1 μm or larger.

### Advantageous Effects

When the apparatus according to the present invention is used, when producing lithium sulfide by a reaction between a lithium raw material and hydrogen sulfide, the reaction is performed under relatively mild conditions compared to the conventional technology, so frequent repairs or replacements due to corrosion and breakdown of reactors and piping are not required, thereby improving the economic efficiency of the process. In addition, since unreacted hydrogen sulfide and a solvent from which moisture has been removed are reused, process costs are reduced so that economic feasibility in mass production is ensured.

Furthermore, moisture and water vapor generated in a lithium sulfide production reaction are effectively removed to prevent a reverse reaction into lithium hydroxide and promote a forward reaction so that high-quality lithium sulfide can be produced with high purity and high yield. In addition, particle size can be controlled in the micrometer range without a separate crushing space or crushing stage, thereby providing excellent convenience and mass production.

### DESCRIPTION OF DRAWINGS

FIG. 1 is a schematic diagram illustrating an example of an apparatus for producing lithium sulfide according to an embodiment of the present invention.

FIGS. 2 to 5 are schematic diagrams illustrating each step of a method of producing lithium sulfide according to embodiments of the present invention.

### DETAILED DESCRIPTION

Hereinafter, embodiments of the present invention will be described in detail with reference to the accompanying drawings. When designating components in each drawing, it should be noted that, where possible, identical components are given the same reference numerals, even when they appear in different drawings. Furthermore, when describing embodiments of the present invention, detailed descriptions of known components or functions will be omitted when they are deemed to hinder understanding of the embodiments of the present invention.

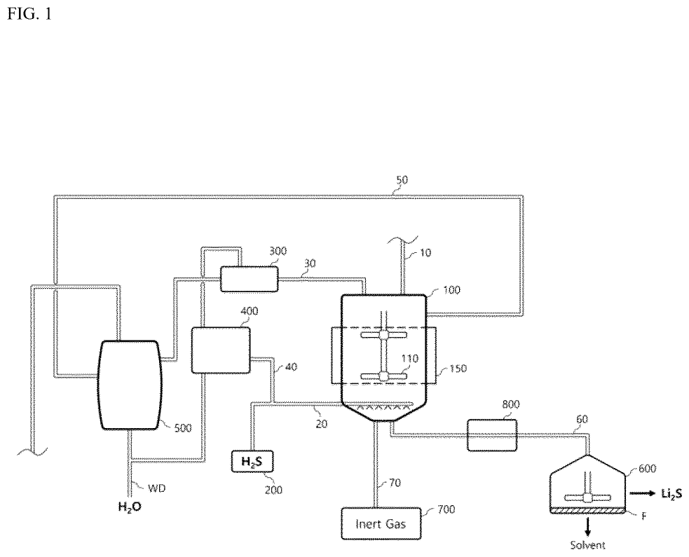

Hereinafter, with reference to FIG. 1 and the like, an apparatus for producing lithium sulfide according to the present invention and a method of producing lithium sulfide using the same will be described in more detail.

### Apparatus for Producing Lithium Sulfide

An apparatus for producing lithium sulfide according to one embodiment of the present invention may include: a reaction chamber 100 having a predetermined reaction space and provided with a solvent and a lithium raw material; a hydrogen sulfide supply portion 200 for supplying hydrogen sulfide to the reaction chamber; a heating portion 150 for heating the reaction space; a lithium sulfide recovery portion 600 for receiving and recovering lithium sulfide produced by a reaction between the lithium raw material and the hydrogen sulfide within the reaction chamber; a condensation portion 300 for recovering and selectively condensing gas discharged from the reaction chamber; a hydrogen sulfide resupply portion 400 for recovering unreacted hydrogen sulfide (H₂S) passing through the condensation portion and supplying it back into the reaction chamber; and a solvent resupply portion 500 for selectively recovering a solvent from a mixture of the solvent liquefied in the condensation portion and water and supplying the solvent back into the reaction chamber. Meanwhile, although not shown, a separately provided supply means such as a circulation pump may be used as a means to promote material movement between components within the production apparatus.

The reaction chamber 100 is a chamber having a predetermined reaction space in which a lithium sulfide production reaction is performed, and a lithium raw material and hydrogen sulfide react in the reaction space and synthesize lithium sulfide (Li₂S). The shape of the reaction chamber is not particularly limited as long as it has the predetermined reaction space. A solvent used for a wet reaction may be provided in the reaction space of the reaction chamber 100.

The solvent provided in the reaction chamber may be a solvent used in a wet reaction, and it may be an aprotic solvent, specifically, one selected from cycloheptane, cyclooctane, methylcyclohexane, dimethylcyclohexane, trimethylcyclohexane, ethylcyclohexane, diethylcyclohexane, propylcyclohexane, isopropylcyclohexane, dipropylcyclohexane, butylcyclohexane, tert-butylcyclohexane, methylcycloheptane, and methylcyclooctane; octane, isooctane, nonane, isononane, decane, isodecane, undecane, dodecane, hexadecane, and octadecane; toluene, o-, m-, and p-xylene, 1,3,5-trimethylbenzene (mesitylene), 1,2,4- and 1,2,3-trimethylbenzene, ethylbenzene, propylbenzene, isopropylbenzene, butylbenzene, isobutylbenzene, tert-butylbenzene, and cyclohexylbenzene; naphthalene, decahydronaphthalene (decalin), 1- and 2-methylnaphthalene, 1- and 2-ethylnaphthalene; tetrahydrofuran, 2-methyltetrahydrofuran, 2,5-dimethyltetrahydrofuran, 1,4-dioxane, dibutyl ether, isoamyl ether, dihexyl ether, 1,2-dimethoxyethane; and a combination thereof.

Meanwhile, the lithium raw material may be supplied to the reaction space of the reaction chamber along a lithium raw material supply line 10. Supply of the lithium raw material may be carried out by charging it into the reaction chamber all at once, or via a conveyor belt installed outside the reaction chamber 100 to implement an automated/semi-automated process. In addition, the lithium raw material supply line 10 may be installed vertically or inclined to allow the lithium raw material to move into the reaction chamber by gravity. In addition, a separately provided ventilation means may be used to move the lithium raw material. A stirring member 110 may be provided within the reaction chamber to promote the lithium sulfide production reaction or to crush the product. The stirring member 110 may be, for example, a rotating disk, a rotary stirrer, a propeller, or the like.

The lithium raw material of the present invention is a reactant that generates lithium sulfide by reacting with hydrogen sulfide (H₂S) supplied in the step described below, and it may be one selected from lithium hydroxide (LiOH), lithium hydroxide monohydrate (LiOH·H₂O), lithium carbonate (Li₂CO₃), and a combination thereof. For example, the lithium raw material may be lithium hydroxide monohydrate (LiOH·H₂O). In this case, since securing the raw material is easy and the cost is low, it may be more suitable for ensuring economic efficiency and mass production.

The heating portion 150 may be provided adjacent to or in contact with the reaction chamber to heat the predetermined reaction space. For example, the heating portion 150 may be a heater, electric heating wire, or infrared heater mounted on the exterior of the reaction chamber 100, and it may perform heating so that the reaction space has a temperature ranging from 120 to 300° C., specifically from 120 to 250° C., and more specifically from 120 to 200° C.

Meanwhile, for the lithium raw material and hydrogen sulfide to react smoothly, the temperature within the reaction chamber must be sufficiently elevated. As shown in <Chemical Equation 1> below, water (H₂O) is produced as a byproduct of the reaction between lithium hydroxide and hydrogen sulfide, which may cause a reverse reaction of the lithium sulfide production reaction and, by being located between lithium hydroxide particles or between the particles and the solvent, reduce the area of the lithium raw material that reacts with hydrogen sulfide.

2LiOH+H₂S→Li₂S+2H₂O <Chemical Equation 1>

Therefore, the reaction space may be heated to a temperature of 120° C. or higher to remove moisture and water vapor, thereby promoting the forward reaction and obtaining high-purity lithium sulfide. However, since lithium hydroxide, one of the lithium raw materials, has a melting point of 445° C., it is preferable that the temperature of the reaction space does not exceed 445° C. Furthermore, since an excessive increase in the reaction temperature may cause corrosion of the reaction apparatus and piping, heating must be performed within the above-described temperature range.

Meanwhile, as the temperature of the reaction space increases, there is a greater risk of corrosion of an inner surface of the reaction chamber 100 and piping due to hydrogen sulfide, so the reaction chamber 100 and piping may be manufactured of a material having high heat resistance and corrosion resistance. For example, the reaction chamber 100 may be made of one material selected from the group consisting of Hastelloy, stainless steel (SUS), alumina, quartz, and a combination thereof, specifically, one material selected from the group consisting of Hastelloy X, stainless steel 304 (SUS 304), stainless steel 310 (SUS 310), stainless steel 316 (SUS 316), alumina, quartz, and a combination thereof. When the reaction chamber and piping are made of the above-described materials and the temperature of the reaction space is maintained within the above-mentioned range, frequent repair or replacement of equipment such as the reaction chamber 100 and piping can be prevented, while sufficiently promoting the reaction between hydrogen sulfide and the lithium raw material, thereby obtaining high-purity lithium sulfide.

The hydrogen sulfide supply portion 200 is provided to supply hydrogen sulfide to the reaction chamber 100. Specifically, the hydrogen sulfide supply portion 200 may be a device for supplying hydrogen sulfide to one side or a bottom of one side of the reaction chamber. Meanwhile, a hydrogen sulfide supply line 20 connecting the hydrogen sulfide supply portion 200 and the reaction chamber 100 may be provided with a sparger or an inline disperser (not shown) for bubbling supply of hydrogen sulfide. The sparger and inline disperser may be devices for high-pressure mixing of supplied fluids, and these devices may be controlled to have an optimal pressure and temperature range so that hydrogen sulfide (H₂S) is supplied into the reaction chamber in a bubbled state.

Hydrogen sulfide supplied into the reaction chamber along the hydrogen sulfide supply line 20 may be sprayed downward by a spray nozzle. When hydrogen sulfide is sprayed downward, the time that hydrogen sulfide (H₂S) gas remains in the solvent increases, thereby increasing the efficiency of the lithium sulfide production reaction and reducing the proportion of unreacted hydrogen sulfide discharged outside the reaction chamber.

The condensation portion 300 may be for selectively condensing gas discharged from the reaction chamber 100 along an exhaust line 30, and it may be provided with a separate cooling means (not shown) for this purpose. For example, the condensation portion may be a condenser utilizing a heat exchange method. For example, when the temperature of the condensation portion is set to be less than 100° C., specifically less than 70° C., and more specifically less than 50° C., the water vapor and solvent discharged from the reaction chamber are liquefied, but unreacted hydrogen sulfide passes through the condensation portion in a gaseous state.

The hydrogen sulfide re-supply portion 400 may be a device for recovering unreacted hydrogen sulfide (H₂S) that has passed through the condensation portion and supplying the recovered unreacted hydrogen sulfide to the reaction chamber 100 along the hydrogen sulfide re-supply line 40. In addition, the hydrogen sulfide re-supply portion 400 may include a moisture removal portion (not shown). Specifically, the unreacted hydrogen sulfide (H₂S) recovered from the condensation portion may be supplied back to the reaction chamber 100 with moisture completely removed while passing through the hydrogen sulfide re-supply portion, and when the unreacted hydrogen sulfide is recovered and re-supplied in this manner, the economic efficiency of the process is improved. Meanwhile, the moisture removal portion is not particularly limited as long as it is capable of removing moisture/water vapor from the recovered unreacted hydrogen sulfide gas. For example, it may be a device configured to selectively liquefy and remove only water vapor by pressurizing gas under high pressure conditions. In this case, unlike a method of removing moisture through cooling, a separate heating process is not required before supplying the recovered unreacted hydrogen sulfide gas to the reaction chamber, which may be advantageous in terms of process economy and efficiency.

The hydrogen sulfide re-supply line 40 may be directly connected to the reaction chamber 100 or may be connected to the hydrogen sulfide supply line 20. When the hydrogen sulfide re-supply line 40 is directly connected to the reaction chamber, the hydrogen sulfide re-supply line 40 may be provided with a sparger or an inline disperser (not shown) for bubbling supply of hydrogen sulfide, similar to the above-described hydrogen sulfide supply line 20.

The solvent re-supply portion 500 is a device component that receives a mixture of the solvent and water liquefied from the condensation portion 300, separates them based on the difference in boiling point or specific gravity, and then selectively recovers only the solvent. The solvent recovered from the solvent re-supply portion 500 may be supplied back into the reaction chamber 100 along a solvent re-supply line 50. Meanwhile, one or more solvent re-supply portions may be provided, and when there are two or more solvent re-supply portions, they may be provided in a series or parallel form as needed. The solvent re-supply portion 500 may be a Dean-Stark trap or an oil-water separator. Meanwhile, the water separated in the above-described process is removed along a water discharge line WD.

The lithium sulfide recovery portion 600 is a component to which a product generated in the reaction chamber 100 is delivered, and the product may be delivered along the lithium sulfide recovery line 60. In the lithium sulfide recovery portion, a process for removing solvents and impurities and drying may be carried out before obtaining the final lithium sulfide. Meanwhile, the lithium sulfide recovery portion is not particularly limited, but it may be a chamber having a shape such as a cylinder, a square, a rectangle, a cone, an inverted cone. For example, the lithium sulfide recovery portion may include a filter reactor including one or more selected from a blower, an impeller, and a filter member F, or a vacuum filter capable of performing vacuum drying.

The blower may be a device provided at a side end or top of the lithium sulfide recovery portion to generate a gas flow in a horizontal or vertical direction. The gas flow generated by the blower removes the solvent and impurities remaining on the surface of the lithium sulfide product by moving them toward the filter member. The gas supplied from the blower may be an inert gas, as described above.

The impeller may be provided to be capable of moving up/down/left/right within the lithium sulfide recovery portion and may have one or more shapes selected from a paddle, a propeller, and a turbine. Meanwhile, the impeller may be a component that operates during the removal of impurities and drying of the product delivered to the lithium sulfide recovery portion to promote this process.

The filter member F may be a component that discharges the solvent and impurities separated from lithium sulfide to the outside as described above and may be made of one material selected from Hastelloy, stainless steel (SUS), and a combination thereof, specifically, one material selected from Hastelloy X, stainless steel 304 (SUS 304), stainless steel 310 (SUS 310), stainless steel 316 (SUS 316), and a combination thereof. In addition, the filter member F may be a mesh filter that sieves particles having a particle size of 1 μm or more.

The inert gas supply portion 700 is a component for supplying an inert gas into the reaction chamber by bubbling it, and for example, the inert gas may be supplied along an inert gas supply line 70 connected to a bottom of the reaction chamber. The inert gas may be one selected from nitrogen (N₂), argon (Ar), helium (He), and a combination thereof. Meanwhile, the inert gas supply portion or the inert gas supply line may be provided with a sparger or an inline disperser (not shown) for bubbling supply. Meanwhile, the flow of the inert gas supplied by bubbling may be controlled to have a flow rate in a range of 1 to 10 kph.

An inline mixer 800 may be provided in a lithium sulfide recovery line 60 that connects the reaction chamber 100 and the lithium sulfide recovery portion 600. The inline mixer may be provided to crush the product obtained by the lithium sulfide production reaction, that is, lithium sulfide particles, into a desired size. Specifically, the inline mixer operates when the product is transferred to the lithium sulfide recovery portion after the lithium sulfide production reaction is completed, thereby crushing the lithium sulfide particles into a predetermined size range in the presence of a solvent. Meanwhile, the inline mixer may be configured to control the stirring speed and stirring time in order to control the average particle size (D50) of the finally obtained lithium sulfide into a predetermined size range. For example, the inline mixer may operate at a stirring speed in the range of 300 to 2,000 rpm and may operate for 1 to 20 hours per operation.

### Method of Producing Lithium Sulfide

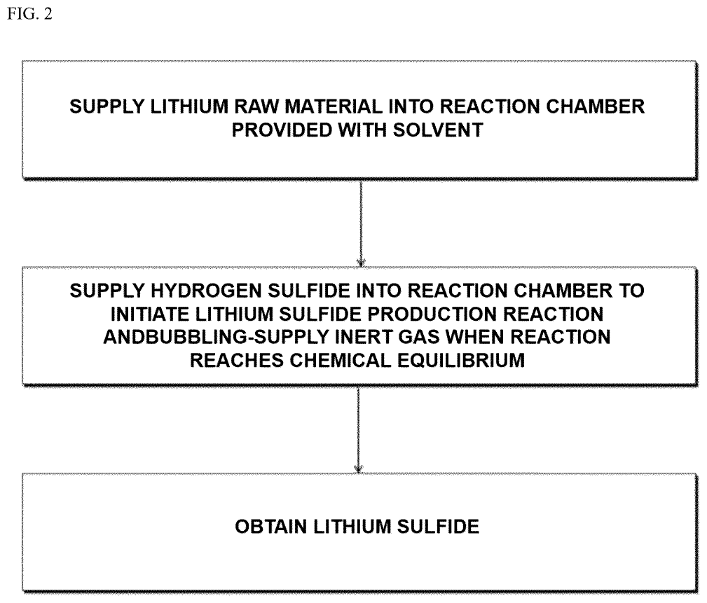

A method of producing lithium sulfide according to one embodiment of the present invention, for which the above-described apparatus may be used, includes: a) a step of supplying a lithium raw material into a reaction chamber provided with a solvent; b) a step of supplying hydrogen sulfide (H₂S) into the reaction chamber to initiate a lithium sulfide (Li₂S) production reaction; and c) a step of transferring a product obtained in Step b) to a lithium sulfide recovery portion to obtain lithium sulfide (see FIG. 2).

First, a lithium raw material is supplied into a reaction chamber provided with a solvent (Step a)).

The reaction chamber is a chamber having a predetermined reaction space in which a lithium sulfide production reaction is performed, and a lithium raw material and hydrogen sulfide react in the reaction space to synthesize lithium sulfide. The detailed components of the reaction chamber will be described later.

The solvent provided in the reaction chamber may be a solvent used in a wet reaction, and it may be an aprotic solvent, and the specific types are described above.

The solvent in the above-described step may be provided in a volume ranging from 50% to 80% based on a total volume of the reaction chamber. When the solvent is included in an amount less than the above-described volume range, there may be a problem in which lithium sulfide particles synthesized during the lithium sulfide production reaction splash and stick to walls of the reaction space or grow and become fixed. On the other hand, when the amount of the solvent exceeds the above-described volume range, the space for an inert gas or hydrogen sulfide gas (H₂S) supplied to satisfy pressure conditions required during the lithium sulfide production reaction is reduced, making it difficult to control the pressure conditions, and the solvent may also flow back to another component of the apparatus.

The lithium raw material of the present invention is a reactant that reacts with hydrogen sulfide gas (H₂S) supplied and produces lithium sulfide in a step described later, and it may be one selected from lithium hydroxide (LiOH), lithium hydroxide monohydrate (LiOH·H₂O), lithium carbonate (Li₂CO₃), and a combination thereof. For example, the lithium raw material may be lithium hydroxide monohydrate (LiOH·H₂O), and in this case, the raw material is easy to obtain and the cost is low, so it may be more suitable for ensuring economic feasibility and mass production.

The method may further include, after the above-described Step a) and before Step b) that will be described later, a step of removing moisture within the reaction chamber.

Specifically, the step may be performed to prevent a reverse reaction of the lithium sulfide (Li₂S) production reaction in Step b), which will be described later, from being accelerated, by removing moisture within the reaction chamber, thereby preventing the reduction in a conversion rate into lithium sulfide. For example, the step may be performed by heating with a heating portion, which will be described later, for one to five hours while maintaining the reaction space within the reaction chamber at a temperature ranging from 80 to 200° C., specifically, from 90 to 150° C.

In the above-described step, stirring may be performed to selectively remove moisture within the reaction chamber while suppressing solvent vaporization as much as possible. For example, the stirring may be performed at a stirring speed ranging from 300 to 800 rpm. In addition, in the above-described step, an inert gas may be supplied by bubbling to ensure smooth moisture removal.

Next, hydrogen sulfide (H₂S) is supplied into the reaction chamber to initiate a lithium sulfide (Li₂S) production reaction (Step b)).

The lithium raw material supplied in Step a) may be synthesized into lithium sulfide (Li₂S) through a wet reaction with hydrogen sulfide (H₂S) gas supplied into the reaction chamber in Step b) under solvent conditions. When the lithium raw material is lithium hydroxide, a specific reaction chemical equation may be as shown in <Chemical Equation 1>.

The lithium sulfide production reaction according to one embodiment of the present invention may be performed at a temperature in the reaction chamber ranging from 120 to 300° C., specifically from 120 to 250° C., and more specifically from 120 to 200° C., and the pressure may be performed at a pressure ranging from 0.01 to 5.0 bar, specifically from 1.5 to 3.0 bar, and more specifically from 2 to 2.5 bar. In addition, the reaction may be performed for 10 to 60 hours, and stirring may be performed during the reaction to promote the reaction.

According to FIG. 2 and a first embodiment of the present invention, a lithium sulfide (Li₂S) production reaction may be performed in Step b), but Step b) may include a process of bubbling an inert gas and then re-supplying hydrogen sulfide to the reaction chamber when the reaction reaches chemical equilibrium, and the inert gas bubbling and hydrogen sulfide re-supply process of Step b) may be repeated one or more times.

Specifically, when hydrogen sulfide is supplied into the reaction chamber, a lithium sulfide production reaction is initiated, and a point is reached where the rates of a forward reaction and a reverse reaction become equal and thus chemical equilibrium is achieved during the reaction. At this point, when the reaction is terminated as is, it may be difficult to obtain a desired level of lithium sulfide purity, and therefore, bubbling supply of an inert gas is performed according to the present invention. The bubbling supply of the inert gas discharges moisture remaining in the solvent and water vapor present in the reaction chamber to the outside of the reaction chamber, thereby breaking the chemical equilibrium, allowing the forward reaction to resume. At this time, when hydrogen sulfide is supplied again to the reaction chamber, the lithium sulfide production reaction is initiated again. Therefore, when the inert gas bubbling and hydrogen sulfide re-supply process of Step b) is repeated, the conversion rate of the lithium raw material into lithium sulfide can be maximized.

Meanwhile, the inert gas may be supplied to one end or the bottom of the reaction chamber, and the bubbling supply of the inert gas may be performed for one to five hours each time, specifically one to three hours, but this may vary depending on various factors such as the amount of the lithium raw material and the size of the reaction chamber. The inert gas according to one embodiment of the present invention may be one selected from nitrogen (N₂), argon (Ar), helium (He), and a combination thereof, and it may be, for example, nitrogen (N₂). When nitrogen (N₂) is used as the inert gas, it has the advantages of being inexpensive and easy to handle, without significantly affecting the lithium sulfide production reaction.

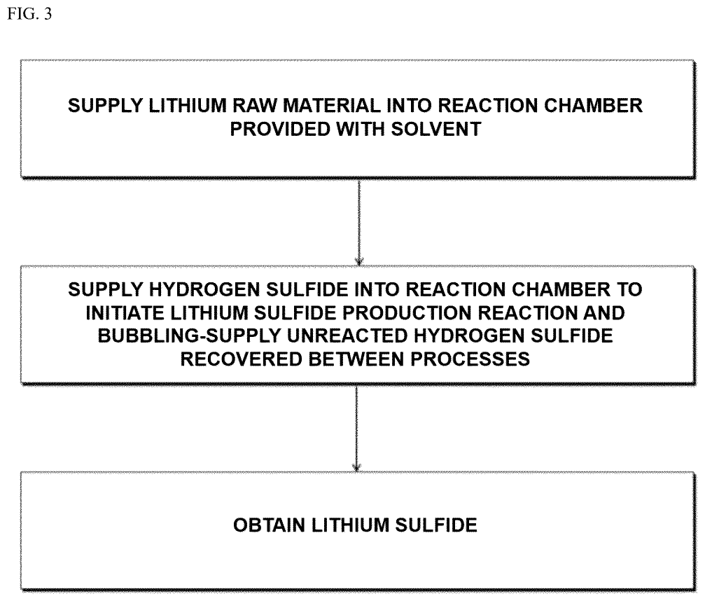

According to FIG. 3 and a second embodiment of the present invention, unlike Example 1, a lithium sulfide (Li₂S) production reaction may be performed in Step b), but Step b) may include a process of maintaining the pressure in the reaction chamber within a predetermined range by bubbling unreacted hydrogen sulfide recovered between processes.

Specifically, when hydrogen sulfide is supplied into the reaction chamber, a lithium sulfide production reaction is initiated, and a point is reached where the rates of a forward reaction and a reverse reaction become equal and thus chemical equilibrium is achieved during the reaction. At this point, when the reaction is terminated as is, it may be difficult to obtain a desired level of lithium sulfide purity, and therefore, bubbling supply of an inert gas is performed according to the present invention. The bubbling supply of unreacted hydrogen sulfide recovered between processes discharges moisture remaining in the solvent and water vapor present in the reaction chamber to the outside of the reaction chamber, thereby breaking the chemical equilibrium, allowing the forward reaction to resume. At this time, the unreacted hydrogen sulfide recovered between processes and supplied by bubbling also serves as a reactant that reacts with the lithium raw material, and so the lithium production reaction is resumed. Therefore, when bubbling supply is continuously performed, the conversion rate of the lithium raw material into lithium sulfide can be maximized.

For example, the amount of unreacted hydrogen sulfide recovered between processes and supplied by bubbling may correspond to the amount of hydrogen sulfide consumed during the lithium sulfide production reaction. However, since the amount of unreacted hydrogen sulfide recovered between processes and supplied by bubbling may be less than the amount of hydrogen sulfide consumed during the lithium sulfide production reaction, fresh hydrogen sulfide may be additionally supplied to maintain the pressure within the reaction chamber within a predetermined range.

The hydrogen sulfide (H₂S) supplied or re-supplied into the reaction chamber in Step b) may be one selected from among newly supplied hydrogen sulfide from a hydrogen sulfide supply portion, unreacted hydrogen sulfide recovered between processes, and a combination thereof. Meanwhile, the unreacted hydrogen sulfide recovered between processes may be hydrogen sulfide discharged outside the reaction chamber without reacting in Step b) and then resupplied to the reaction chamber through a circulation process, and the circulation of the unreacted hydrogen sulfide may mean passing through a condensation portion, a hydrogen sulfide re-supply portion, and the like, which will be described later.

In addition, in this step, a part of the solvent may be vaporized and discharged outside the reaction chamber. Therefore, the solvent may be replenished during the reaction, and in this case, the solvent may be one selected from a newly supplied solvent, a solvent recovered between processes, and a combination thereof. Meanwhile, the solvent recovered between processes may be a solvent vaporized in Step b), discharged outside the reaction chamber, and then re-supplied to the reaction chamber through a circulation process. The circulation of the solvent may mean passing through a condensation portion, a solvent re-supply portion, and the like, which will be described later.

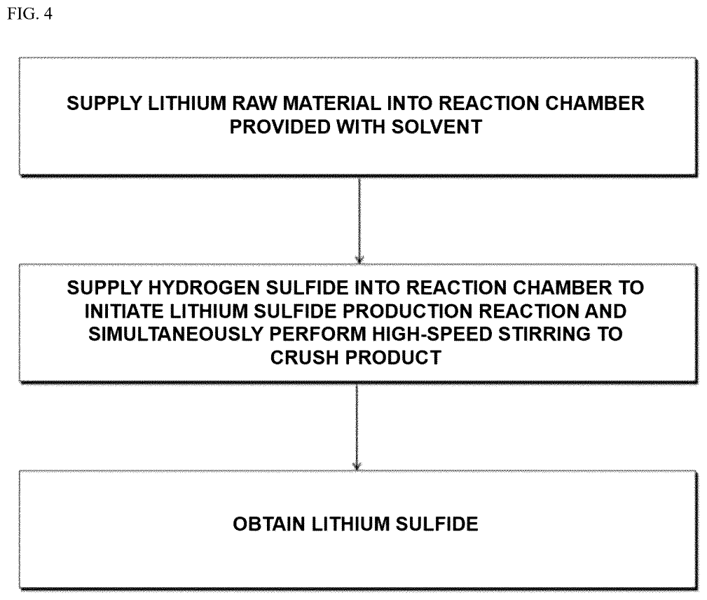

According to FIG. 4 and a third embodiment of the present invention, a process of crushing a product by performing high-speed stirring during the lithium sulfide (Li₂S) production reaction may be included. Specifically, the high-speed stirring may be performed by controlling the stirring speed within the range of 1,000 to 2,000 rpm, specifically 1,400 to 1,600 rpm, using a stirring member provided within the reaction chamber, thereby controlling an average particle size (D50) of finally obtained lithium sulfide within a predetermined range of several micrometers.

In this regard, Korean Patent Application No. 2021-0134601 (filed on Oct. 12, 2021) discloses a method of pulverizing lithium sulfide by mechanically crushing by a method such as ball milling or jet milling after obtaining the same, and conventionally, the particle size of lithium sulfide was generally controlled by crushing lithium sulfide in a separate space through the above-described steps after finally obtaining the same. On the other hand, when lithium sulfide is produced and wet crushing is performed by high-speed stirring under solvent conditions as in the present invention, unlike conventional methods, a separate crushing space or a separate crushing step is not required, which is economical and also has the advantage of blocking dust generation.

Next, a product obtained in Step b) is transferred to a lithium sulfide recovery portion to obtain lithium sulfide (Step c)).

The step may include a process of generating a gas flow to remove the solvent and impurities and dry the lithium sulfide.

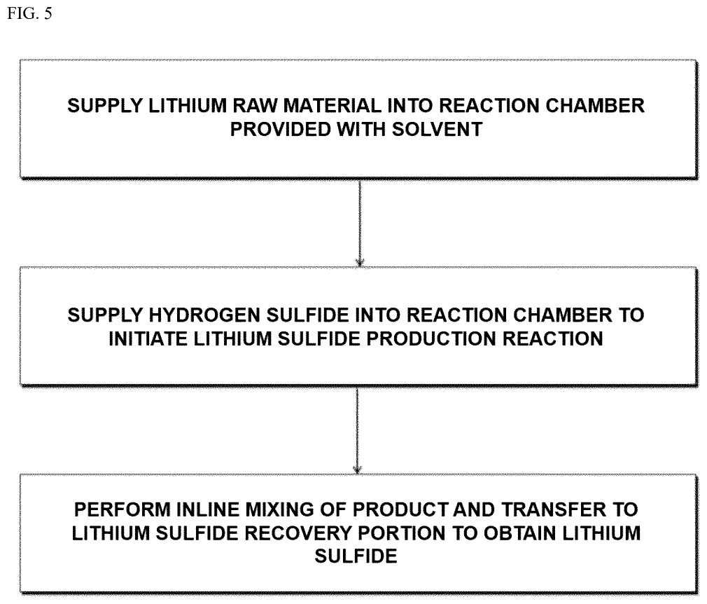

According to FIG. 5 and a fourth embodiment of the present invention, the product produced in the reaction chamber is transferred to the lithium sulfide recovery portion along the lithium sulfide recovery line, and at this time, the product is crushed in an inline mixer provided in the lithium sulfide recovery line. Specifically, the crushing using the inline mixer may be performed at a stirring speed in the range of 300 to 2,000 rpm, and the inline mixing time may be adjusted as needed. Meanwhile, by adjusting the stirring speed and stirring time, the average particle size (D50) of the lithium sulfide finally obtained in the lithium sulfide recovery portion may be controlled within a predetermined range of several micrometers.

In this regard, Korean Patent Application No. 2021-0134601 (filed on Oct. 12, 2021) discloses a method of pulverizing lithium sulfide by mechanically crushing by a method such as ball milling or jet milling after obtaining the same, and conventionally, the particle size of lithium sulfide was generally controlled by crushing lithium sulfide in a separate space through the above-described steps after finally obtaining the same. On the other hand, when wet crushing is performed with an inline mixer under solvent conditions during product transfer as in the present invention, unlike conventional methods, a separate crushing space or a separate crushing step is not required, which is economical and also has the advantage of blocking dust generation.

As described below, the lithium sulfide recovery portion may include a filter reactor including at least one selected from a blower, an impeller, and a filter member F, or a vacuum filter capable of performing vacuum drying.

Specifically, the process of removing the solvent and impurities may be performed using a horizontal or vertical gas flow generated from a blower installed in a filter reactor, and the lithium sulfide may be dried simultaneously during this process. The gas flow may be a flow of an inert gas selected from nitrogen (N₂), argon (Ar), helium (He), or a combination thereof. The gas flow may have a rate in a range of 1 to 10 kph. During this process, the lithium sulfide recovery portion may have a temperature ranging from 80 to 150° C., specifically from 80 to 130° C.

Meanwhile, the percentage of the lithium raw material that is consumed by the reaction in Steps a) through c) of the present invention may be 97.99% or greater, specifically 98.99% or greater, and more specifically 99.99% or greater.

When the above-described apparatus according to the present invention is used, when producing lithium sulfide by a reaction between a lithium raw material and hydrogen sulfide, the reaction is performed under relatively mild conditions compared to the conventional technology, so frequent repairs or replacements due to corrosion and breakdown of reactors and piping are not required, thereby improving the economic efficiency of the process. In addition, since unreacted hydrogen sulfide and a solvent from which moisture has been removed are reused, process costs are reduced so that economic feasibility in mass production is ensured.

Furthermore, moisture and water vapor generated in a lithium sulfide production reaction are effectively removed to prevent a reverse reaction into lithium hydroxide and promote a forward reaction so that high-quality lithium sulfide can be produced with high purity and high yield. In addition, particle size may be controlled in the micrometer range without a separate crushing space or crushing stage, providing excellent convenience and mass production properties.

### Lithium Sulfide

Lithium sulfide (Li₂S) produced according to one embodiment of the present invention has an average particle size (D50) ranging from 1 to 200 μm, specifically an average particle size (D50) ranging from 1 to 120 μm, and more specifically an average particle size (D50) ranging from 1 to 10 μm. Furthermore, the lithium sulfide (Li₂S) may have a Brunauer-Emmett-Teller (BET) specific surface area ranging from 1 to 14 m²/g.

In addition, the lithium sulfide produced according to one embodiment of the present invention has a carbon content of less than 0.5% by weight, specifically less than 0.3% by weight. The carbon content may refer to the total carbon content in the finally obtained lithium sulfide, measured using a non-dispersive infrared (ND-IR) analysis method. Meanwhile, the finally obtained lithium sulfide according to the present invention may have a purity of 97.99% or more, specifically 98.99% or more, and more specifically 99.99% or more, and the purity may be measured by an X-ray diffraction (XRD) semi-quantitative analysis.

Furthermore, according to an additional embodiment of the present invention, the lithium sulfide can be utilized as a key material in the manufacture of a sulfide-based solid electrolyte such as argyrodite-based electrolytes or Li-P-S (LPS)-based electrolytes.

Specifically, a lithium all-solid-state secondary battery according to one embodiment of the present invention may include: a positive electrode; a negative electrode facing the positive electrode; and a sulfide-based solid electrolyte interposed between the positive electrode and the negative electrode and made of the above-described lithium sulfide. In addition, the lithium solid-state secondary battery may be applied to one or more products/technical fields selected from electric vehicles (EVs), hybrid electric vehicles (HEVs), energy storage systems (ESSs), urban air mobility (UAM), mobile devices, laptops, electronic devices, tablets, drones, robots, and home appliances.

The above description is merely an illustrative description of the technical idea of the present invention, and those skilled in the art will understand that various modifications and changes can be made without departing from the essential features of the present invention. Therefore, the embodiments disclosed in the present invention are intended to illustrate, rather than limit, the technical idea of the present invention, and the scope of the technical idea of the present invention is not limited by these embodiments. The scope of protection of the present invention should be interpreted by the following claims, and all technical ideas within a scope equivalent thereto should be interpreted as being included in the scope of the rights of the present invention.

### REFERENCE NUMERALS

10: Lithium raw material supply line
20: Hydrogen sulfide supply line
30: Exhaust line
40: Hydrogen sulfide re-supply line
50: Solvent re-supply line
60: Lithium sulfide recovery line
70: Inert gas supply line
WD: Water (H₂O) discharge line
100: Reaction chamber
110: Stirring member
150: Heating portion
200: Hydrogen sulfide supply portion
300: Condensation portion
400: Hydrogen sulfide re-supply portion
500: Solvent re-supply portion
600: Lithium sulfide recovery portion
700: Inert gas supply portion
800: Inline mixer
F: Filter member

What is claimed is:

1. An apparatus for producing lithium sulfide, comprising:
a reaction chamber having a predetermined reaction space and provided with a solvent and a lithium raw material;
a hydrogen sulfide supply portion for supplying hydrogen sulfide to the reaction chamber;
a heating portion for heating the reaction space;
a lithium sulfide recovery portion for receiving and recovering lithium sulfide produced by a reaction between the lithium raw material and the hydrogen sulfide within the reaction chamber;
a condensation portion for recovering and selectively condensing gas discharged from the reaction chamber;
a hydrogen sulfide resupply portion for recovering unreacted hydrogen sulfide (H₂S) passing through the condensation portion and supplying it back into the reaction chamber; and
a solvent resupply portion for selectively recovering a solvent from a mixture of the solvent liquefied in the condensation portion and water and supplying the solvent back into the reaction chamber.

2. The apparatus of claim 1, further comprising an inert gas supply portion that supplies inert gas by bubbling it into the reaction chamber.

3. The apparatus of claim 1, further comprising, within the reaction chamber, a stirring member that promotes a reaction between the lithium raw material and hydrogen sulfide or crushes a product.

4. The apparatus of claim 1, further comprising an inline mixer in a lithium sulfide recovery line that connects the reaction chamber and the lithium sulfide recovery portion.

5. The apparatus of claim 1, wherein the reaction chamber is made of one material selected from the group consisting of Hastelloy, stainless steel (SUS), alumina, quartz, and a combination thereof.

6. The apparatus of claim 1, hydrogen sulfide supplied to the reaction chamber from one or more devices selected from the hydrogen sulfide supply portion and the hydrogen sulfide resupply portion is bubbled by a sparger or an inline dispersing device before being supplied into the reaction chamber.

7. The apparatus of claim 1, wherein the heating portion is a device mounted on an outer surface of the reaction chamber and heats the reaction space to a temperature ranging from 120 to 300° C.

8. The apparatus of claim 1, wherein the lithium raw material is one selected from lithium hydroxide (LiOH), lithium hydroxide monohydrate (LiOH·H₂O), lithium carbonate (Li₂CO₃), and a combination thereof.

9. The apparatus of claim 1, wherein the solvent resupply portion is a Dean-Stark trap or oil-water separator that separates solvent and water using differences in boiling point or specific gravity of substances.

10. The apparatus of claim 1, wherein the lithium sulfide recovery portion includes a filter reactor or a vacuum filter, and when the lithium sulfide recovery portion is a filter reactor, it includes one or more selected from a blower, an impeller, and a filter member (F).

11. The apparatus of claim 10, wherein the blower is a device that is provided on a side end or top of the lithium sulfide recovery portion and generates a gas flow in a horizontal or vertical direction.

12. The apparatus of claim 10, wherein the impeller is provided so as to be movable in up, down, left, and right directions within the lithium sulfide recovery portion and has one or more forms selected from a paddle, a propeller, and a turbine.

13. The apparatus of claim 10, wherein the filter member is made of one material selected from Hastelloy, stainless steel (SUS), and a combination thereof and is a mesh filter that sieves particles with a particle size of 1 μm or larger.
